(19) United States
(12) Patent Application Publication
(10) Pub. No.: US 2012/0100366 A1
(43) Pub. Date: Apr. 26, 2012

(54) WEAR RESISTANT COATINGS CONTAINING PARTICLES HAVING A UNIQUE MORPHOLOGY

(75) Inventors: Timothy Dumm, Westerville, OH (US); Kan-yin Ng, Columbus, OH (US)

(73) Assignee: DIAMOND INNOVATIONS, INC., Worthington, OH (US)

(21) Appl. No.: 13/289,255

(22) Filed: Nov. 4, 2011

Related U.S. Application Data
(63) Continuation-in-part of application No. 12/560,899, filed on Sep. 16, 2009.
(60) Provisional application No. 61/187,789, filed on Jun. 17, 2009.
(60) Provisional application No. 61/097,422, filed on Sep. 16, 2008.

(51) Int. Cl. B32B 5/16; C08K 3/10; B32B 27/04; C09D 1/00; B32B 15/00; B32B 17/00

(52) U.S. Cl. 428/335; 106/286.1; 524/435

(57) ABSTRACT

A composite coating including a plurality of monocrystalline diamond particles having an irregular surface, wherein the surface roughness of said particle is less than about 0.95, a material selected from the group of metals, metal alloys polymer, glass, carbon and combinations thereof and optional additives.

### CROSS-REFERENCE TO RELATED APPLICATIONS

The instant application is a continuation-in-part of U.S. patent application Ser. No. 12/560,899, filed Sep. 16, 2009 which claims the benefit of U.S. Provisional Patent Application Ser. No. 61/187,789 filed Jun. 17, 2009 and U.S. Provisional Patent Application Ser. No. 61/097,422 filed Sep. 16, 2008,

### TECHNICAL FIELD AND INDUSTRIAL APPLICABILITY

The present invention relates to wear resistant coatings that use hard particles having a unique morphology. More particularly, the invention relates to composite coatings that incorporate monocrystalline diamond particles having a modified surface texture for enhancing wear resistance or other characteristics in industrial applications.

### BACKGROUND

Abrasive and corrosive wear are fundamental problems that are associated with many surfaces that encounter friction forces and corrosive environments. This wear, or erosion, often results in damage to the surface and can cause equipment or process downtime for replacement parts. Depending on the scale of the process that is forced to shut down, significant costs can be associated with lost production time when changing worn parts plus the cost of the parts themselves. Common failure modes are: changes in dimensional form; development of pits, holes, grooves or other wear patterns that change the uniformity of a surface; changes in tolerance that leads to inefficiencies in the performance of a component. Many types of coatings or surface treatments have been developed that can be applied to surfaces for improving the abrasive and corrosive wear of the base material. Examples of common coatings include thermal sprays; heat treatments for nitriding, carbiding or boriding; PVD and CVD techniques, anodizing and electroplating.

One such electroplated coating is a composite coating that comprises an electroless nickel layer having wear resistant particles incorporated within the layer. The particles, which are usually either silicon carbide or diamond, are co-deposited as the nickel layer forms onto the base material. The particles impart a more wear resistant characteristic to the nickel layer giving a composite wear resistance that is as good as or better than most of the common hard coatings.

The wear rate of the composite surface is largely determined by the concentration of hard particles and degree of particle adhesion within the nickel matrix that surrounds each particle. Since electroless nickel does not chemically bond to the surface of the particles, they are only held within the matrix by mechanical adhesion or entrapment. In an abrasive environment, the softer nickel matrix will wear at a faster rate than the particles. At some point, when a sufficient amount of the surrounding nickel layer is worn away, the particle will be pulled out of the surface by the shear forces causing the abrasive wear. To a large extent, the degree of particle retention in the nickel matrix will depend on particle morphology.

In the past, methods of modifying the diamond particles have been used to provide improved retention of the diamond particles, i.e., in bonds for grinding and sawing tools. These include modifying monocrystalline diamond particles with mild chemical or heating treatments to provide a mildly etched surface. Other methods include coating the surface of the diamond to improve the retention of the particle in a bond system. However, there is a need for coatings having improved wear and retention properties.

The foregoing and other objects, features and advantages of the invention will become apparent from the following disclosure in which one or more embodiments of the invention are described in detail. It is contemplated that variations in procedures may appear to a person skilled in the art without departing from the scope of or sacrificing any of the advantages of the invention.

### BRIEF DESCRIPTION OF THE DRAWINGS

FIG. 1A shows example of typical monocrystalline diamond in a cross section of a composite diamond coating.

FIG. 1B shows example of typical monocrystalline diamond in a cross section of a composite diamond coating showing vacant sites or pop-outs where diamond used to be.

FIGS. 2A-2F shows examples of conventional, unmodified diamond and modified diamond.

FIG. 3 shows data from a Taber wear test using two panels coated with convention, unmodified monocrystalline diamond and modified diamond.

FIGS. 4A-4D shows scanning electron microscope images of wear areas of Taber panels containing composite diamond coating and Taber panels containing conventional, unmodified diamond and modified diamond.

FIG. 5 is a Table that shows the concentration of conventional, unmodified diamond particles and modified diamond particles in a wear zone of Taber panels after 10,000 grinding cycles.

### DETAILED DESCRIPTION OF EMBODIMENTS

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to the understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which it is being used. Therefore, about 50% means in the range of 45%-55%.

### DEFINITIONS

In describing and claiming embodiments, the following terminology will be used in accordance with the definitions set forth below.

The term “abrasive”, as used herein, refers to any material used to wear away softer material.

The term “monocrystalline diamond”, as used herein, refers to diamond that is formed either by high-pressure/high-temperature synthesis or a diamond that is naturally formed. Fracture of monocrystalline diamond proceeds along atomic cleavage planes. A monocrystalline diamond particle breaks relatively easily at the cleavage planes.

The term “particle”, as used herein, refers to a discrete body. A particle is also considered a crystal or a grain.

The term “pit”, as used herein, refers to an indentation or crevice in the surface of a particle, either an indentation or crevice in the surface of a two-dimensional image or an indentation or crevice in an object.

The term “polycrystalline diamond”, as used herein, refers to diamond formed by explosion synthesis resulting in a polycrystalline particle structure. Each polycrystalline diamond particle consists of large numbers of microcrystallites less than about 100 angstroms in size. Polycrystalline diamond particles do not have cleavage planes.

The term “spike”, as used herein, refers to a sharp projection pointing outward from the centroid of a particle, a sharp projection pointing outward from the centroid of a two-dimensional image or a sharp projection pointing outward from an object.

The term “superabrasive”, as used herein, refers to an abrasive possessing superior hardness and abrasion resistance. Diamond and cubic boron nitride are examples of superabrasives and have Knoop indentation hardness values of over 7500.

The term “surface roughness”, as used herein, refers to the measurement of a two-dimensional image that quantifies the extent or degree of pits and spikes of an object's edges or boundaries as stated in the CLEMEX image analyzer, Clemex Vision User's Guide PE 3.5 ©2001. Surface roughness is determined by the ratio of the convex perimeter divided by the perimeter.

$$Surface Roughness = \frac{ConvexPerimeter}{Perimeter} . \qquad i$$

Note that as the degree of pits and spikes increases, the surface roughness factor decreases.

The term “sphericity”, as used herein, refers to the estimate of the enclosed area of a two dimensional image or object (4 πA) divided by the square of perimeter (p²).

$$Sphericity = \frac{4 π A}{{p}^{2}} . \qquad ii$$

An embodiment includes a process for applying a wear and corrosion resistant coating whereby the coating contains diamond particles that have been modified so as to provide a roughened surface texture uniformly co-deposited within nickel layer. In an embodiment, the surface modified diamond particles may be coated with a thin layer of titanium or titanium/chrome alloy. In the process of coating the diamond particles with titanium (Ti), the Ti is chemically bonded to the surface of the diamond and a titanium carbide (TiC) or chrome carbide (CrC) interface is formed. In an embodiment, the outer layers of the coating are Ti or Cr metal.

Composite electroless nickel coatings are available today that are being used as wear resistant and corrosion resistant surfaces. The most common types of particulate matter used in these composites are silicon carbide and diamond. Electroless nickel composites with Teflon and boron nitride particles are also common, but these coatings are intended for improved lubricity and release properties than for wear resistance. Useful particles that may be used with the coating are described in U.S. patent application Ser. No. 12/560,899 at page 7, paragraphs 54-56. In an embodiment, modified monocrystalline diamond particles described in U.S. patent application Ser. No. 12/560,899 at page 13, paragraph 78 through page 16, paragraph 87 are used. The processes used to modify these particles are taught in U.S. Ser. No. 12/560,899 at page 7, paragraph 59 through page 10, paragraph 65 and at page 10, paragraph 68 through page 13, paragraph 77.

The particles used within the composite coatings may be less than about 10 um in size and comprise about 30 to about 50% by volume of the applied coating. Coating thicknesses, after application to an article, range from about 20 to about 50 um. Examples of coatings may be found in U.S. Pat. No. 4,997,686 at page 4, paragraphs 10-31 and in U.S. Pat. No. 5,145,517 at page 4, paragraphs 8-29 respectively. Other examples useful coatings/coating processes are taught in U.S. Patent Application Publication No. 2006/0246275 at page 2, paragraphs 28-29 and page 4, paragraph 52 through page 5, paragraph 69; and U.S. Pat. No. 7,562,858 at columns 3-6. Examples of coatings/processes and material that may be coated can be found in U.S. Pat. No. 7,377,477 at column 7, line 11 through column 18, line 7. The aforementioned patents and applications are herein incorporated by reference in their entirety. Commercial manufacturers/coaters of composite coatings include Surface Technology Inc, Robbinsville, N.J. and ESK Ceramics (Ceradyne, Calif.), Kempten, Germany.

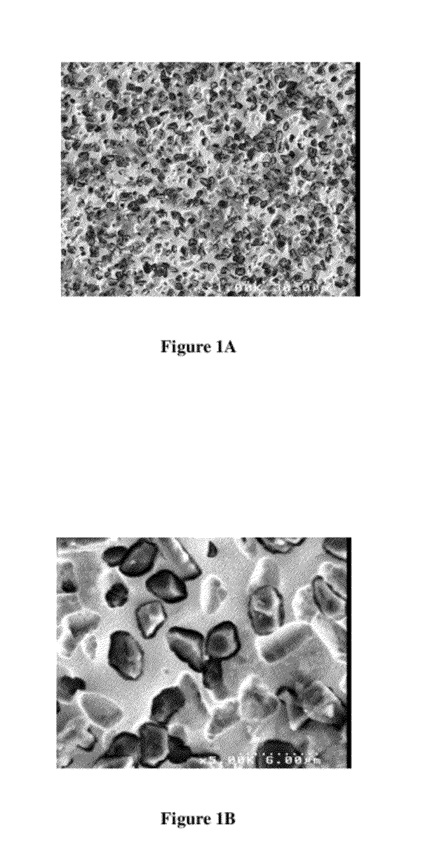

In an embodiment, existing technology for applying the composite coatings, standard electroless nickel plating baths may be used. The particulate matter is dispersed within the plating baths using chemical surfactants. When the reducing agent is added, the nickel ions precipitate out and plate onto the surface to be coated. In the process of precipitating out of solution, the nickel ions create a driving force that captures suspended particles near the surface thereby entrapping these within the forming nickel layer. The particles are co-deposited within the nickel and a uniform coating of particles in a nickel matrix is formed (see FIG. 1A). FIG. 1A shows the surface of a typical composite diamond coating showing uniform distribution of particles within nickel layer.

By adding wear resistant particles to the nickel layer, the wear resistance of the coating is dramatically improved. The particles usually protrude slightly from the surface of the nickel matrix and bear the shear force of the opposing surface that causes the wear. The cumulative force on the particles and the simultaneous wear of the surrounding nickel layer eventually causes the particles to be pulled from the surface leaving an empty socket of nickel (see FIG. 1B). FIG. 1B shows the surface of conventional composite diamond coating showing mechanical retention of particles by surrounding nickel layer. Pull-out sites are also visible.

The degree to which the particles are mechanically held within the surrounding nickel matrix would determine the ease with which the particles could be pulled from the surface. The degree of premature particle “pop-outs” would ultimately determine the wear rate of the composite coating. Particles held firmly in place would create a more wear resistant surface than particles that popped out with relative ease.

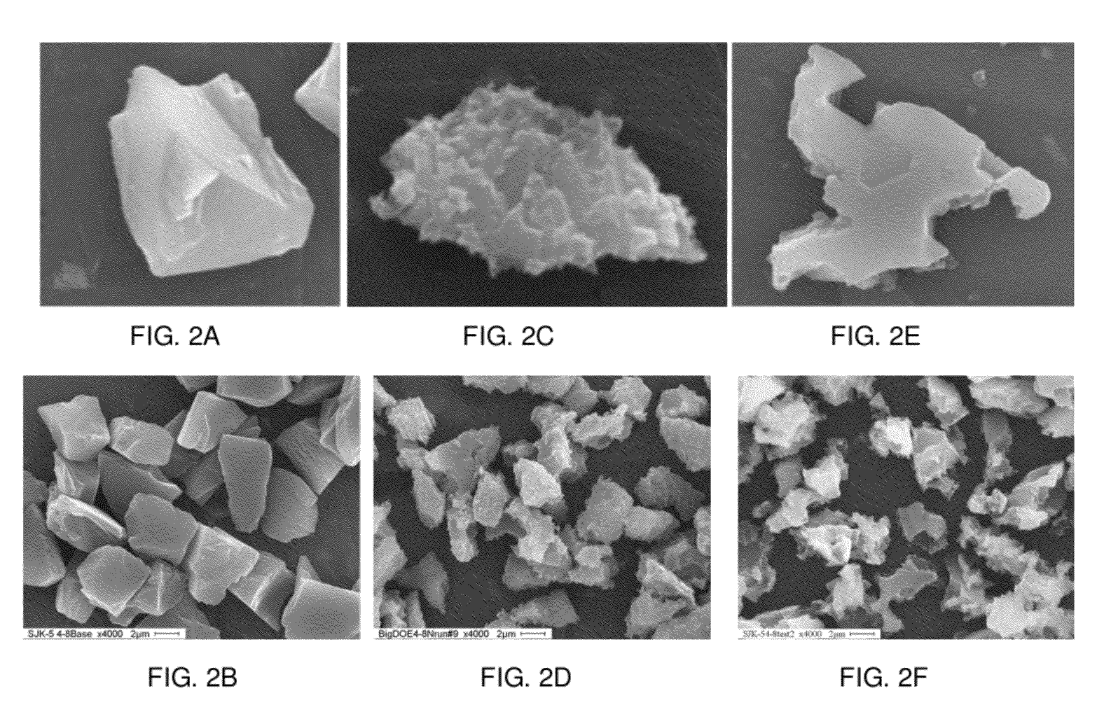

An embodiment relates to composite coatings using abrasive or hard particles having a unique surface morphology. In an embodiment, the diamond particles in the coating have a significantly roughened surface texture whereby many intricate pockets or etch-pits are established on the surface of the diamond. The diamond particles of an embodiment contain one or more pits and/or spikes. Examples of the diamond particles exhibiting these features is shown in FIGS. 2C, 2D, 2E and 2F. FIGS. 2C and 2D show monocrystalline diamond particles modified by the process taught in U.S. patent application Ser. No. 12/560,899 at page 7, paragraph 59 through page 10, paragraph 65, which is herein incorporated by reference, having an average surface roughness of 0.78 and an average sphericity of 0.46. FIGS. 2D and 2E show monocrystalline diamond particles modified by the process taught in U.S. patent application Ser. No. 12/560,899 at page 10, paragraph 68 through page 13, paragraph 77, which is herein incorporated by reference, having an average surface roughness of 0.68 and an average sphericity of 0.34. FIGS. 2A and 2B show conventional, diamond particles (unmodified by the aforementioned processes) having an average surface roughness of 0.89 and an average sphericity of 0.64.

The lengths of the spikes and depths of the pits vary according to the modification treatment parameters. The average depth of the pits on a particle ranges in size from about 5% to about 70% of the longest length of the particle. For more detailed information on the characteristics of the modified diamond, refer to U.S. patent application Ser. No. 12/560,899

In an embodiment, modified diamond is used in a composite coating for improved wear performance. The function of the matrix in a composite coating is for holding or retaining the hard particles. If the retention mechanism is mostly mechanical, then particles with smooth surfaces will be more likely to be pulled out of the matrix from frictional or shear forces compared with particles that have a rough, irregular surface. Since the hard particles provide the majority of the wear resistance, the wear rate of the coating will be reduced when the particles are more easily pulled from the matrix. In an embodiment, the matrix material can be metallic, polymeric, vitreous or combinations thereof. The hard particles are superabrasive particles of diamond or cubic boron nitride. The diamond is may be monocrystalline diamond and of sizes ranging from about 0.1 to about 100 microns in size. The particle concentration of diamond in the composite coating is about 5 to about 80 volume percent and can have thickness from about 1 micron to about 1000 microns. In one embodiment, monocrystalline diamond particles may be used. Monocrystalline diamond particles in sizes of less than about 100 microns are useful. However, diamond particles in sizes over about 100 microns may be used as well. The sizes of the diamond particles range from about 0.1 to about 1000 microns. One example of diamond particles that may be used is SJK-5 4-8 micron, synthetic industrial diamond particles manufactured by Diamond Innovations, Inc. (Worthington, Ohio, U.S.A) which have been modified by the process taught in U.S. patent application Ser. No. 12/560,899 at page 7, paragraph 59 through page 10, paragraph 65, and at page 10, paragraph 68 through page 13, paragraph 77.

In an embodiment, other abrasives may be subjected to a modification process taught in U.S. patent application Ser. No. 12,560,899 as described above. Examples of abrasives include any material, such as minerals, that are used for shaping or finishing a workpiece. Superabrasive materials such as natural and synthetic diamond and boron, carbon and nitrogen compounds may be used. Suitable diamond materials may be crystalline or polycrystalline. Other examples of abrasive grains may include calcium carbonate, emery, novaculite, pumice dust, rouge, sand, ceramics, alumina, glass, silica, silicon carbide, and zirconia alumina.

In another embodiment, the modified abrasive particles may be optionally coated with a coating, after modification and before their addition to the composite coating, with a material selected from Groups IVA, VA, VIA, IIIb and IVb of the periodic table and including alloys and combinations thereof. A non-metallic coating that may be used is silicon carbide.

Lubricating material may be used in the composite coating and may include but is not limited to MoS₂, graphite, hexagonal boron nitride, polytetrafluoroethylene, and mixtures of these.

### Example I

Two steel 4 inch×4 inch Taber test panels were obtained for coating with a composite diamond coating. One panel was coated with a coating using 6-10 micron conventional, unmodified monocrystalline diamond and the second panel was coated with 6-10 micron modified diamond. Both panels were coated separately as follows:
1. Each steel panel was secured to a rotating frame on a fixture that could be removed from the plating bath.
2. While attached to the frame, each steel panel was soaked in dilute HCl (50/50) at room temperature for 5 minutes or until the liquid turned yellow and cloudy.
3. After the treatment with HCl, each panel was scrubbed in a uniform direction with a Scotch-Brite pad.
4. After cleaning, each fixture with panel was immediately placed into the nickel plating bath.
5. The nickel plating bath was prepared by mixing 600 ml (6 vol %) of Niklad 767 AR (MacDermid Inc., Denver, Colo.) with 1500 ml (15 vol. %) of Niklad 767B and 7900 ml of deionized water. The total volume of the nickel bath was 10 liters.
6. The bath was heated to approx. 190 degrees F. (87-88 C) and was maintained at this temperature using a thermocouple controlled hot-plate.
7. As the nickel bath was heating, 50 grams of either 6-10 micron monocrystalline diamond powder (REGULAR; unmodified conventional diamond) or 50 grams per liter of 6-10 micron modified diamond (SMD) were added to the bath.
8. When the diamond was added to the bath and the temperature was at least 80 C, the fixture with the panel was connected to a motor that rotated the steel panel at a rate of 50 to 60 rpm. A pump was used to lift the diamond that settled to the bottom of the tank and recirculate to the top of the tank. This created a constant concentration of diamond settling onto the rotating steel panel.
9. The time was noted when the steel panel was placed into the plating bath and every fifteen minutes, 60 ml of Niklad HpH and 60 ml of Niklad AR were added to replenish the nickel concentration.
10. Each plate was left in the bath for 2 hours after which the pump and the hot-plate were turned off and the plate was removed from the bath.
11. Each coated steel plate was rinsed with deionized water and dried.
12. Each plate was heat treated by placing the panels into a furnace for 1 hour at 300 C in air.
13. When the panels were cool, a light grit blast with glass beads using 40 psi air pressure was used to clean any loose material and tarnish stains from each panel.

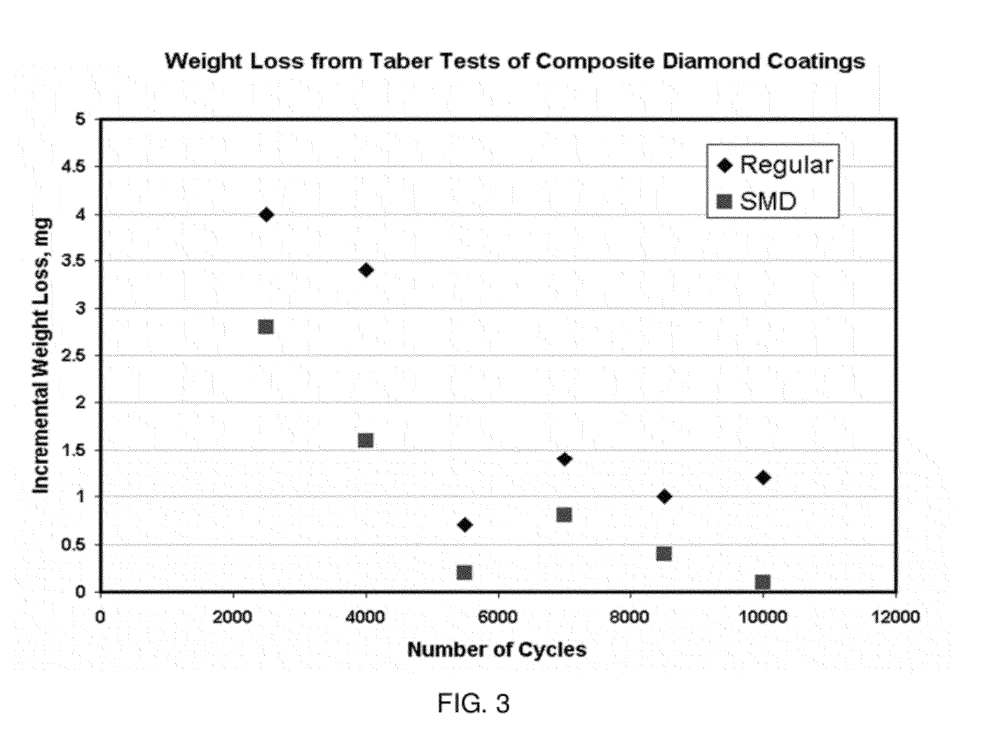

Taber abrasion tests (Taber Industries, North Tonawanda, N.Y.) were performed on each coated steel panel. A characteristic rub-wear action is produced by contact of the test sample, turning on a vertical axis, against the sliding rotation of two abrading wheels. The wheels are driven by the sample in opposite directions about a horizontal axis displaced tangentially from the axis of the sample. One abrading wheel rubs the specimen outward toward the periphery and the other, inward toward the center. The resulting abrasion marks form a pattern of crossed arcs over an area approximately 30 square centimeters. This area is described as the wear track. The Taber test was performed using a Taber Abraser Model 5135 machine with CS-10 wheels and 1 kg load on each wheel. Each panel was accurately weighed before the Taber test and a total of 10,000 cycles were performed on each panel. At 1500 cycle intervals, each panel was removed from the Taber test machine and weighed and the weight was recorded. After each test was complete, the weight loss was determined and plotted as shown in FIG. 3. The panels containing the modified diamond are designated as “SMD” and the panels containing the conventional, unmodified diamond are designated as “REGULAR” in FIG. 3.

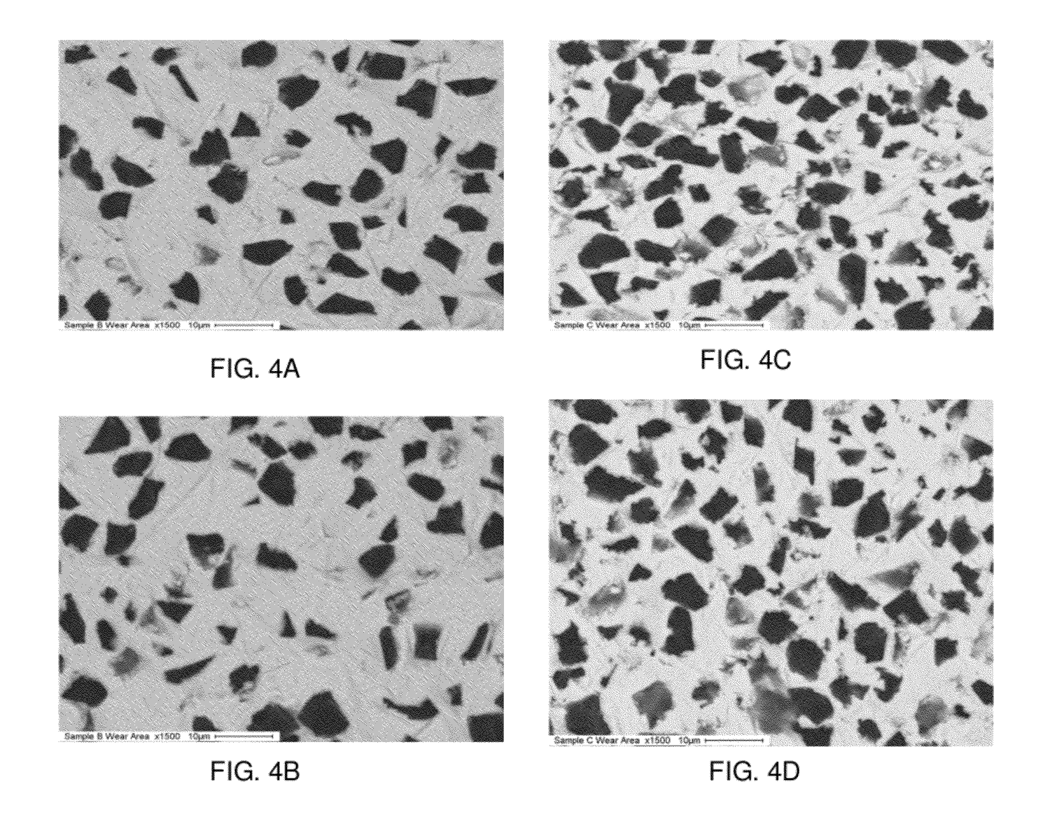

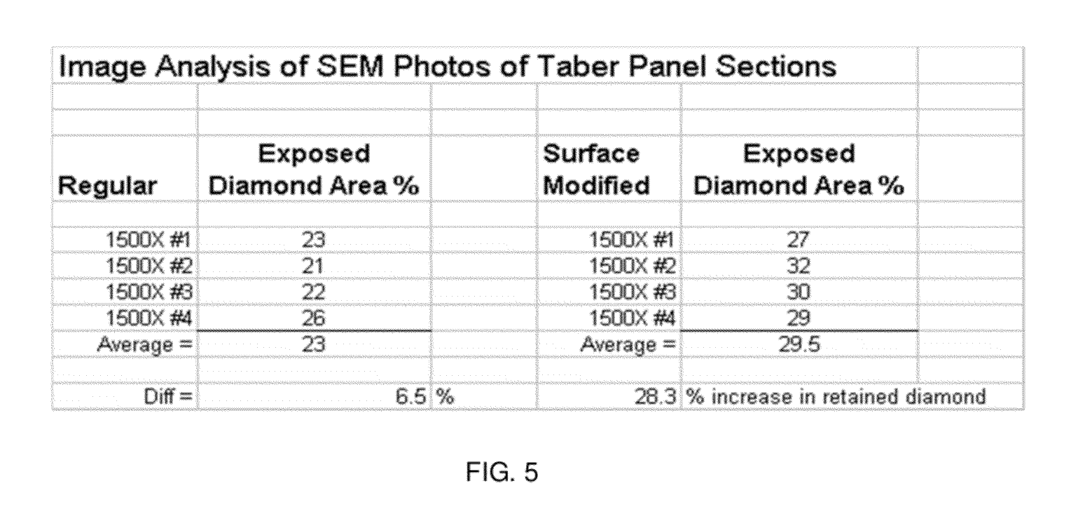

As can be seen from this data, the panel using the modified diamond provided a more wear resistant surface than the panel using the conventional, unmodified monocrystalline diamond. Additionally, a section of each panel was obtained by cutting a section using EDM wire method. Each section was then placed into the scanning electron microscope so that the surface of panel, where the grinding wheel abraded a wear track, could be examined. Images of each section were obtained using scanning electron microscope in backscatter mode at 1500× as shown in FIGS. 4A, 4B, 4C and 4D. FIGS. 4A and 4B show conventional, unmodified monocrystalline diamond and FIGS. 4C and 4D show modified diamond. Automated image analysis was performed on these images and the results are shown in FIG. 5. These results show that the wear track of the panel using the conventional, unmodified diamond has a diamond concentration of 23% whereas the diamond concentration within the wear track of the panel using the modified diamond has a concentration of 29.5%. This data clearly shows that the wear track of the panel using modified diamond retained 28 percent more diamond after 10,000 cycles than did the panel using conventional, unmodified diamond. This is consistent with the fact that there was less weight loss, and hence less wear, from the panel during Taber testing.

It is believed that more of the modified diamond particles are retained in the composite coating because the roughened surfaces provide significantly more areas on each diamond for the metal matrix to penetrate and thus mechanically hold the diamond particles more firmly in place.

### EQUIVALENTS

Although the invention has been described in connection with certain exemplary embodiments, it will be evident to those of ordinary skill in the art that many alternatives, modifications, and variations may be made to the disclosed invention in a manner consistent with the detailed description provided above. Also, it will be apparent to those of ordinary skill in the art that certain aspects of the various disclosed example embodiments could be used in combination with aspects of any of the other disclosed embodiments or their alternatives to produce additional, but not herein explicitly described, embodiments incorporating the claimed invention but more closely adapted for an intended use or performance requirements. Accordingly, it is intended that all such alternatives, modifications and variations that fall within the spirit of the invention are encompassed within the scope of the appended claims.

1. A composite coating comprising:
a. plurality of monocrystalline diamond particles having an irregular surface, wherein the surface roughness of said particle is less than about 0.95;
b. a material selected from the group of metals, metal alloys, polymers, glass, carbon and combinations thereof; and
c. optional additives.

2. The coating of claim 1, wherein the surface roughness of said particles is between about 0.50 and about 0.80.

3. The coating of claim 1, wherein the metal is selected from nickel and nickel alloys.

4. The coating of claim 3, wherein the nickel is electroless nickel.

5. The coating of claim 1, wherein the additives are selected from the group of polymers, fibers, particles, lubricants, materials from Groups IVA, VA, VIA, IIIb and IVb of the periodic table and their alloys and combinations thereof.

6. The coating of claim 1, where the size of the particles ranges from about 0.1 to about 1000 microns.

7. The coating of claim 1, wherein said diamond particles are coated with a material selected from the group of material from Groups IVA, VA, VIA, IIIb and IVb of the periodic table their alloys and combinations thereof.

8. A substrate comprising a composite coating said coating comprising:
a. a plurality of monocrystalline diamond particles having an irregular surface, wherein the surface roughness of said particle is less than about 0.95;
b. a material selected from the group of metals, metal alloys polymer, glass, carbon and combinations thereof; and
c. optional additives.

9. The substrate of claim 8, wherein the average retention of said particles on said substrate is about 25% to about 50% better than that of conventional, unmodified particles.

10. The substrate of claim 8, wherein the surface roughness of said particles is between about 0.50 and about 0.80.

11. The substrate of claim 8, wherein the metal is selected from nickel and nickel alloys.

12. The substrate of claim 11, wherein the nickel is electroless nickel.

13. The substrate of claim 8, wherein the additives are selected from the group of polymers, fibers, particles, materials from Groups IVA, VA, VIA, IIIb and IVb of the periodic table and their alloys and combinations thereof.

14. The substrate of claim 8, wherein the coating thickness is about 20 to about 50 μm on said substrate.

15. The substrate of claim 6, wherein the particles comprise about 20 to about 50% by volume of the applied coating.

16. A method of making a composite coating comprising the steps of:
a. providing a plurality of monocrystalline diamond particles having an irregular surface, wherein the surface roughness of said particle is less than about 0.95;
b. providing a material selected from the group of metals, metal alloys polymer, glass, carbon and combinations thereof; and
c. providing optional additives
d. blending said particles, said material and said optional additives to form said coating.
